(19) United States
(12) Patent Application Publication
(10) Pub. No.: US 2022/0170342 A1
(43) Pub. Date: Jun. 2, 2022

(54) VALVE ARRANGEMENT

(71) Applicant: PETROLEUM TECHNOLOGY COMPANY AS, Stavanger (NO)

(72) Inventor: Kristian Harestad, Stavanger (NO)

(21) Appl. No.: 17/623,725

(22) PCT Filed: Jun. 24, 2020
(86) PCT No.: PCT/NO2020/050178

§ 371 Date: Dec. 29, 2021

(30) Foreign Application Priority Data
Jul. 3, 2019 (NO) 20190833

(51) Int. Cl. E21B 34/02; F16K 31/122

(52) U.S. Cl. CPC E21B 34/02; F16K 31/122

(57) ABSTRACT

A valve arrangement for a wellhead of a hydrocarbon well comprises a valve for mounting in a port of a wellhead, and an actuator device for actuating the valve to move to an open position. The actuator device comprises a housing having a through channel extending between a first end, at which the valve is mounted, and a second end. The housing comprises at least one first port that leads into the through channel. The actuator device further comprises an actuator rod that is movably arranged in the through channel and configured to open the valve by the actuator rod being movable between at least a first position and a second position, and a control device arranged to control the movement of the actuator rod.

### CROSS REFERENCE TO RELATED APPLICATIONS

The present application is a National Stage of International Application No. PCT/NO2020/050178, filed on Jun. 24, 2020, which claims priority to Norwegian Patent Application No. 20190833, filed on Jul. 3, 2019, the entire contents of each of which are being incorporated herein by reference.

### TECHNICAL FIELD

The present disclosure relates to a valve arrangement for a well head. For example, the valve arrangement is of a type that may be used to vent fluid from a well annulus or to inject fluid into a well annulus, via e.g. a surface wellhead, a subsea wellhead or a valve tree port, e.g. in a hydrocarbon well.

### BACKGROUND

An oil and/or gas well is drilled into a hydrocarbon bearing earth formation, where the well is typically completed in order to allow hydrocarbon production from the formation. Such a formation may be comprised of several different layers, where each layer may contain one or more hydrocarbon components. Often, such a formation will also contain water, gas, etc. Due to this, the conditions of production, i.e. the amount of oil, gas, water and pressure in the formation, will generally vary through the different layers of the formation, and will also vary during the production lifetime of the well. This may require intervention in the well and for this, suitable equipment is required, such as valve systems.

One such type of equipment is gas lift valves. Hydrocarbon production often begins with sufficient pressure in the formation to force the hydrocarbons to the surface. As the production from the well continues, the reservoir usually loses pressure until sufficient production of hydrocarbons from the well is no longer provided by the formation pressure. In some wells, the formation pressure as such is insufficient to support the production from the well already from the start.

Usually an injection fluid, e.g. high pressure natural gas, is injected into the annulus of production tubing string through a gas lift valve arrangement at the well head. Further down in the tubing string there are gas lift valves incorporated in the production tubing string, which are used to feed the injection fluid from the annulus and into the tubing. At both locations, the gas lift valves must reliably provide one-way fluid flow only and prevent undesirable leakage of production fluids into the annulus and the well head.

As mentioned, the present disclosure relates to a valve arrangement at the well head. Generally such valve arrangements comprise a valve that opens when pressurized injection fluid is feed into the valve, and it closes automatically by means of an elastic element when the infeed of injection fluid stops. However, there are occasions when the pressure difference across the movable member of the valve is such that the valve will not open when injection fluid is fed into the valve, due to higher pressure on the annulus side of the valve. There is then a need to bleed off or vent fluid from the annulus side by forcing the valve to open. There are also occasions when there may be a need to bleed off due to pressure inside the valve arrangement, e.g. when a VR plug is to be removed. This can be done by special arrangements. Examples of prior art are WO 2018/106119 and WO 2009/102214.

An objective of the present disclosure is to provide a valve arrangement that provides advantages over known solutions and techniques with regard to the above mentioned and other aspects.

### SUMMARY

The above objective and other objectives are obtained by the arrangement and method of the present disclosure.

According to one example is provided a valve arrangement for a wellhead of a hydrocarbon well, the valve arrangement comprising
a valve comprising connection elements configured for sealingly and removably mounting of the valve in a port of a wellhead,
an actuator device for actuating the valve to move to an open position, the actuator device comprising
   a housing having a through channel extending between a first end, at which the valve is mounted, and a second end, the housing comprising at least one first port extending through a side wall of the housing and leading into the through channel,
   an actuator rod that is movably arranged in the through channel and which is configured to open the valve by the actuator rod being movable between at least a first position and a second position,
   a control device arranged to control the movement of the actuator rod,
      characterised in that
the through channel comprises a first part and a second part, and that said first part and said second part are separated by a separation device that is arranged in the through channel in a sealing manner,
the first part of the through channel is delimited by the valve at one end and by the separation device at the other end, and
the at least one first port is a bleed off port and/or connectable to an external injection fluid source and it leads into the first part of the through channel.

By arranging the at least one port as a bleed off port and/or connectable to an external injection fluid source and further having this port leading into the first part of the through channel is obtained the advantage of less leakage due to the port being close to the valve. There are also fewer components of the new arrangement as compared to prior art. The new arrangement is simpler, more compact and also cost-saving. If compared to the prior art of WO 2018/106119, the present housing may be compared to what is called the spool in WO 2018/106119. The at least one port can be used for bleed off with regard to pressure built up in the through channel. Alternatively, or in addition, the port can be used for fluid injection, e.g. injection of gas or chemicals into the well via the valve, e.g. for gas lift operations. There may be more than one port leading into the first part of the through channel, in which case there may be separate ports for bleed off and fluid injection, or the ports may be configured for the combined use. Usually, when the port is used for bleed off, a suitable valve will be connected to the port from the outside.

In one example, the actuator rod is located inside the first part of the through channel. The actuator rod is consequently located in a part where the first port is arranged, thus providing for a compact design.

In one example, the actuator rod is configured without a through bore in a longitudinal direction thereof. By having this design it will be possible to exert a higher force on the end of the actuator rod by means of e.g. a piston, due to a larger hydraulic effective area, than if there was an opening of a through bore.

In one example, at least a part of the actuator rod comprises a hollow tube provided with perforations made at an angle to its direction of movement. This will make the piston lighter and the perforations will also work to facilitate injection and bleed off.

In one example, at least a part of the separation device is movable inside the through channel in a sealing manner.

In one example, the separation device comprises a piston that is movable inside the through channel in a sealing manner, wherein the piston is part of the actuator device and the actuator rod is connected to the piston. This provides for a simple solution in that a separation between the space in the through channel where the bleed off/injection port is located and a space in the through channel where a port for the hydraulic control fluid can be located can be achieved by the movable piston itself. This will be explained more later.

In one example, the control device is configured to control a movement of the piston and thereby control the movement of the actuator rod connected to the piston. This is a simple solution since the actuator rod can actually be operated and moved between its positions by means of a piston.

In one example, a chamber is formed in the second part of the through channel and said chamber is delimited by the movable piston and a fixed end member, wherein the housing comprises at least one second port leading into the chamber.

In one example, the second port is connectable to a hydraulic fluid source, and the chamber and the second port are parts of the control device arranged to control the movement of the actuator rod, by means of hydraulic fluid entering the chamber and exerting a force to move the piston and the actuator rod. By this is provided a hydraulic control of the mechanical actuator device comprising the piston and the actuator rod.

In another example, the control device may be an electrical control device that controls the movement of the piston. The second port may then be used for different electronic or electric devices.

The described valve arrangement can be used for fluid injection, including injection of pressurized gas and also injection of chemicals.

Further features and advantages of the present disclosure will also become apparent from the following detailed description of embodiments.

### BRIEF DESCRIPTION OF THE DRAWINGS

The present disclosure will now be described in more detail, with reference being made to the enclosed schematic drawings illustrating examples according to the present disclosure, and in which:

FIG. 1 shows a first example of a valve arrangement according to the present disclosure.

### DETAILED DESCRIPTION

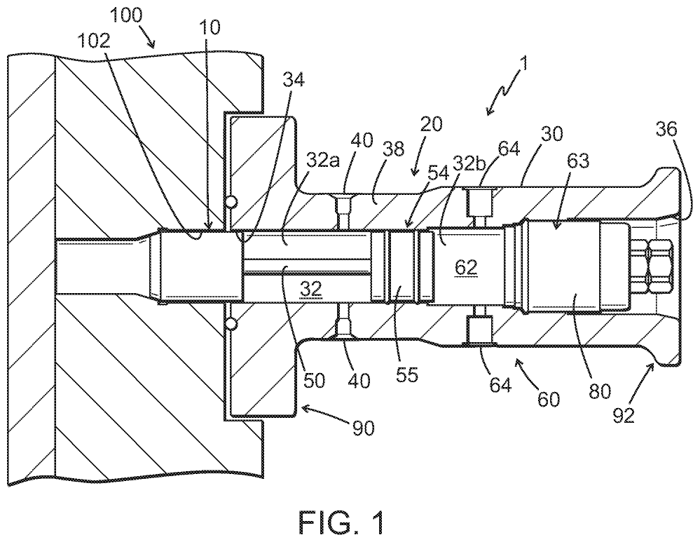

In FIG. 1 is schematically illustrated an example of a valve arrangement 1 for a wellhead 100 of a hydrocarbon well. The valve arrangement comprises a valve 10 comprising connection elements configured for sealingly and removably mounting of the valve in a port 102 of a wellhead, and an actuator device 20 for actuating the valve to move to an open position. The actuator device comprises
a housing 30 having a through channel 32 extending between a first end 34, at which the valve is mounted, and a second end 36, the housing comprising at least one first port 40 extending through a sidewall 38 of the housing and leading into the through channel,
an actuator rod 50 that is movably arranged in the through channel 32 and which is configured to open the valve 10 by the actuator rod being movable between at least a first position and a second position, and
a control device 60 arranged to control the movement of the actuator rod.

The through channel 32 comprises a first part 32a and a second part 32b, and said first part and said second part are separated by a separation device 54 that is arranged in the through channel in a sealing manner. The first part 32a of the through channel 32 is delimited by the valve 10 at one end and by the separation device 54 at the other end. The at least one first port 40 is a bleed off port and/or connectable to an external injection fluid source and it leads into the first part 32a of the through channel 32.

The actuator rod 50 is located inside the first part 32a of the through channel 32.

At least a part of the separation device 54 is movable inside the through channel 32 in a sealing manner. In the example in FIG. 1, the separation device 54 comprises a piston 55 that is movable inside the through channel 32 in a sealing manner. The piston is part of the actuator device 20 and the actuator rod 50 is connected to the piston. The seals are schematically illustrated in the figure as O-rings on the circumferential surface of the piston, but they can of course also be located in the internal surface of the channel 32, or have any other suitable configuration.

In other words, the actuator rod 50 may also be described as being connected to the separation device 54.

The control device 60 is configured to control the movement of the piston 55 and thereby control the movement of the actuator rod 50 connected to the piston. The piston and the actuator rod can be moved by the control device 60 between a first position, in which the valve 10 is closed and a second position in which valve 10 is open, and back to the first position closing the valve.

In the shown example, the actuator rod 50 is configured without a through bore in the longitudinal direction thereof. This is illustrated in the example of FIG. 1.

In an alternative example, at least a part of the actuator rod may comprise a hollow tube provided with perforations made at an angle to its direction of movement. The example shown in FIG. 1 could naturally be modified to include such an actuator rod. The perforations may generally be made in the transverse direction of the actuator rod and extend through the actuator rod, from one side to the opposing side.

In one example, a chamber 62 is formed in the second part 32b of the through channel 32 and said chamber is delimited by the movable piston 55 and a fixed end member 63. The housing 30 comprises at least one second port 64 leading into the chamber 62. In one example, the second port is connectable to a hydraulic fluid source. The chamber 62 and the second port 64 are thus parts of the control device 60 arranged to control the movement of the actuator rod 50, by means of hydraulic fluid entering the chamber 62 and exerting a force to move the piston 55 and the actuator 50 rod. The fixed end member can e.g. be a valve removal plug (VR-plug) or some other type of plug or connection that is fixed and prevents leakage of fluid from the chamber 62. A valve arrangement according to this example is shown in FIG. 1.

As an alternative to a hydraulic control device, the control device may comprise an electrical control device that controls the movement of the piston. If required, the second port may be used in connection to this. The skilled person would understand what electric or electronic components that are required for this implementation.

Further details and functions will now be described.

The valve 10 in the valve arrangement may generally be a gas lift valve or a surface annular safety valve, in the form of a check valve. For example it may be a valve corresponding to the valve part insertable in the well head as disclosed in WO 2009/102214. The valve is only schematically illustrated in FIG. 1. Such a valve will open when it is pressurized by feeding an injection fluid under pressure into the volume formed by the first part 32a of the through channel 32. The valve will close automatically, by means of being equipped with an elastic element, such as a spring, when the pressure ceases. However, under certain circumstances, as already described, it is necessary to have the possibility to open the valve by force, i.e. mechanically. In order to safely attach the valve 10 and the housing 30 in a wall of a wellhead 100, the housing usually comprises a flange 90 by means of which it can be mounted to a well head. The housing may also be provided with a flange 92 at its other end for attachment to other equipment.

In one example, the first port 40 opening into the first part 32a of the through channel 32, which first channel part is in communication with the valve, may be used for injection of fluid as described above. The port 40 may also, or alternatively, be used as a bleed off port for example when the pressure of a fluid on the well side of the valve is too high.

Bleeding off can be achieved as described in the following, with reference to FIG. 1, showing hydraulic control of the actuator device 20 comprising the actuator rod 50 and the piston 55. By feeding hydraulic fluid under pressure into the chamber 62, via the second port 64, a pressure will be exerted on the movable piston 55. This will cause the actuator device 20, i.e. the piston 55 and the actuator rod 50, to move towards the valve, i.e. to the left in FIG. 1. The end of the actuator rod 50 that faces towards the valve will be configured such that it can engage with the valve and the opening mechanism of the valve. The details of the configuration of the engaging end of the actuator rod will be adapted to the concerned type of valve, as will be understood and can be realised by a skilled person on a case to case basis. When the actuator rod 50 is in contact with the valve it will then provoke the opening of the valve, and fluid from the well side of the valve can flow through the valve and into the first channel part 32a, and further out through the first port 40. After bleed off, the valve may be closed by releasing the hydraulic pressure through the second port 64 which will have the result that the piston and actuator rod move back, to the right in FIG. 1, and the valve closes. Alternatively, the valve 10 can be kept open by the actuator device 20 after bleed off and the first port 40 can then be connected to an injection fluid source, that will feed injection fluid under pressure into the first channel part 32a, through the valve 10 and into the tubing of the well head that the valve is connected to. Alternatively, injection fluid can be fed into the first part 32a of the through channel 32 via another first port 40 leading into the first part 32a.

After the start of injection of injection fluid, the piston 55 with the actuator rod 50 may be retracted and the valve 10 will still keep open by means of pressure from the injection fluid. The piston with the actuator rod will generally retract when the pressure in the chamber 62, connected to the second port 64, is lower than the pressure in the first channel part 32a. This can be achieved by reducing the hydraulic pressure fed into the second port 64. However, there may also be other arrangements that can be used to influence when and how the piston 55 with the actuator rod 50 will retract. As described, the actuator rod 50 is thus movable, by means of the piston being movable, between a first position in which the valve is closed and a second position in which the valve is open, and vice versa. In the first position, the actuator rod 50 does not exert any influence on the valve 10 and the piston 55 is not actuated by any hydraulic fluid pressure. In the second position, the piston has been actuated by the hydraulic pressure and the piston and actuator rod has moved to a position where the actuator rod has worked to open the valve.

In FIG. 1 is illustrated two first ports 40 leading into the first part 32a of the through channel 32. If one of the first ports is used only for bleed off, the other of the first ports may be used for connection to an injection fluid source. Generally, there may be several ports that are also used for other purposes, e.g. to ensure that trapped air can be removed during installation of the valve arrangement, to ensure that pressure testing can be done. Such ports may generally be provided with a plug after installation and testing of the valve arrangement, or have a valve installed for sealing. As shown in FIG. 1, there may also be more than one second port 64 leading into the chamber 62 in the second part 32b of the through channel 32.

Generally, the piston 55 functions as a separation device 54 that separates the volume of the first channel part 32a, where the first port 40 is located and which is closest to the valve 10, from the volume of the chamber 62 located in the second channel part 32b and where the second port 64 is located.

Generally, the piston 55 in combination with the fixed part 56 functions as a separation device 54 that separates the first channel part 32a, where the first port 40 is located and which is closest to the valve 10, from a second channel part 23b, in which the fixed part is located and comprising the open part of the through bore 57 that receives the shaft of the control tool 70.

The different elements disclosed in this description, the following claims or the accompanying drawings, expressed in their specific forms or in terms a means for performing a disclosed function, or a method or process for attaining the disclosed result, may, separately or in any combination of such elements, be utilised for realising the present disclosure in diverse forms thereof.

The present disclosure shall not be considered limited to the illustrated examples, but can be modified and altered in many ways, as realised by a person skilled in the art, without departing from the scope defined in the appended claims. For examples, details from one example may in many cases be applicable also to other examples.

1. A valve arrangement for a wellhead of a hydrocarbon well, the valve arrangement comprising:
a valve comprising connection elements configured to mount for sealingly and removably the valve in a port of a wellhead,
an actuator device configured to actuate the valve to move to an open position, the actuator device comprising:
a housing having a through channel extending between a first end, at which the valve is mounted, and a second end, the housing comprising at least one first port extending through a sidewall of the housing and leading into the through channel,
an actuator rod movably arranged in the through channel and configured to open the valve by the actuator rod being movable between at least a first position and a second position,
a control device arranged to control the movement of the actuator rod,
wherein the through channel comprises a first part and a second part, and the first part and the second part are separated by a separation device that is arranged in the through channel in a sealing manner,
wherein the first part of the through channel is delimited by the valve at one end and by the separation device at the other end, and
wherein the at least one first port is a bleed off port and/or connectable to an external injection fluid source and it leads into the first part of the through channel.

2. The valve arrangement according to claim 1, wherein the actuator rod is located inside the first part of the through channel.

3. The valve arrangement according to claim 1, wherein the actuator rod is configured without a through bore in the longitudinal direction thereof.

4. The valve arrangement according to claim 1, wherein at least a part of the actuator rod comprises a hollow tube provided with perforations made at an angle to its direction of movement.

5. The valve arrangement according to claim 1, wherein at least a part of the separation device is movable inside the through channel in a sealing manner.

6. The valve arrangement according to claim 1, wherein the separation device comprises a piston that is movable inside the through channel in a sealing manner, wherein the piston is part of the actuator device and the actuator rod is connected to the piston.

7. The valve arrangement according to claim 6, wherein the control device is configured to control a movement of the piston and thereby control the movement of the actuator rod connected to the piston.

8. The valve arrangement according to claim 6, wherein a chamber is formed in the second part of the through channel and the chamber is delimited by the movable piston and a fixed end member, wherein the housing comprises at least one second port leading into the chamber.

9. The valve arrangement according to claim 8, wherein the second port is connectable to a hydraulic fluid source, and wherein the chamber and the second port are parts of the control device arranged to control the movement of the piston, by means of hydraulic fluid entering the chamber and exerting a force to move the piston and the actuator rod.

10. The valve arrangement according to claim 6, wherein the control device is an electrical control device that controls the movement of the piston.
